(19) United States
(12) Patent Application Publication
(10) Pub. No.: US 2026/0254030 A1
(43) Pub. Date: Aug. 27, 2026

(54) Mobile Power Bank

(71) Applicant: Toyota Motor Engineering & Manufacturing North America, Inc., Plano, TX (US)

(72) Inventor: Brian K. Woods, Brighton, MI (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 19/062,568

(22) Filed: Feb. 25, 2025

(51) Int. Cl. H01M 50/249; B60L 53/302; B60L 53/53; B60P 7/08; H01M 10/613; H01M 10/625

(52) U.S. Cl. CPC H01M 50/249; B60L 53/302; B60L 53/53; B60P 7/0807; H01M 10/613; H01M 10/625; B60L 2200/28; B60L 2210/10; B60L 2210/40; H01M 2220/20

(57) ABSTRACT

Methods, systems, and apparatus for a mobile power bank. The mobile power bank includes a towed vehicle frame including a trailer coupler whereby the towed vehicle is configured to be towed behind a towing vehicle, and a deck mounted to the towed vehicle frame. The mobile power bank further includes a battery coupled to the towed vehicle frame, the battery is disposed at least one of below or flush with the cargo surface. The mobile power bank further includes a pass-through power inverter coupled to the towed vehicle frame, a DC/DC converter coupled to the towed vehicle frame, and one or more interfaces (e.g., electrical connectors) configured to direct electrical power to, and/or receive electrical power from, the battery.

### BACKGROUND

### Field

The present disclosure relates generally to the field of vehicle equipment and, more particularly, to battery energy storage systems.

### Description of the Related Art

The BESS (Battery Energy Storage System) market as well as the hybrid generator market have products that are large, bulky, and extremely heavy industrial units with either fork pockets (requiring forklifts to move) or they are mounted directly on top of a trailer and therefore minimize the customers' ability to transport other goods on the same trailer.

While diesel or gas generator solutions exist, most options have negative environmental emissions and consistently loud and undesirable operational noise. BESS and/or hybrid generator systems are similarly available (and nearly eliminate the environmental concerns); however, they are often too heavy to be towed by the average vehicle customer.

Accordingly, it is desirable to provide systems, methods, and techniques for a mobile BESS or hybrid generator system that maximizes towing space and capacity.

### SUMMARY

One aspect of the subject matter described in this disclosure may be embodied in a mobile power bank for a vehicle. The mobile power bank can include a towed vehicle frame including a trailer coupler whereby the mobile power bank is configured to be towed behind a towing vehicle. The mobile power bank can include a deck mounted to the towed vehicle frame where the deck defines a cargo surface. The mobile power bank can include a battery coupled to the towed vehicle frame. The battery is disposed at least one of below or flush with the cargo surface. The mobile power bank can include a pass-through power inverter coupled to the towed vehicle frame and a DC/DC converter coupled to the towed vehicle frame. The mobile power bank can include an AC interface in electronic communication with the battery via the pass-through power inverter and a DC interface in electronic communication with the battery via the DC/DC converter.

In one aspect, the subject matter may be embodied in a towed vehicle. The towed vehicle can include a towed vehicle frame including a trailer coupler whereby the towed vehicle is configured to be towed behind a towing vehicle. The towed vehicle can further include a deck mounted to the towed vehicle frame where the deck defines a cargo surface. The towed vehicle can further include a battery coupled to the towed vehicle frame. The battery is disposed at least one of below or flush with the cargo surface. The towed vehicle can further include a pass-through power inverter coupled to the towed vehicle frame. The towed vehicle can further include a DC/DC converter coupled to the towed vehicle frame. The towed vehicle can further include an AC interface in electronic communication with the battery via the pass-through power inverter. The towed vehicle can further include a DC interface in electronic communication with the battery via the DC/DC converter.

In one aspect, the subject matter may be embodied in a method for operating a mobile power bank. The method can include loading one or more items of cargo onto a deck of the mobile power bank, moving the mobile power bank with the loaded items of cargo from a first location to a second location using a towing vehicle, and powering an external component using the mobile power bank. The method can further include connecting the mobile power bank to an external power source. The method can further include powering the external component using the external power source via a pass-through inverter of the mobile power bank. The method can further include charging a battery of the mobile power bank using the external power source.

These and other aspects may optionally include one or more of the following features.

The mobile power bank can further include an outlet connector configured to receive electric power from the battery for powering an external component, the outlet connector is part of at least one of the AC interface or the DC interface.

The mobile power bank can further include an inlet connector configured to receive electric power from an external power source for at least one of charging the battery or assisting in powering the external component. The inlet connector is part of at least one of the AC interface or the DC interface.

The mobile power bank can further include a transfer switch configured to transfer electrical loads between two independent power sources. The battery may be one of the two independent power sources.

The external power source can be the other of the two independent power sources.

The mobile power bank can further include an electronic control unit configured to control one or more parameters of the mobile power bank.

The mobile power bank can further include a power bank cooling circuit including a heat exchanger, a conduit, and a pump configured to move a cooling fluid to transfer a heat from the battery to the heat exchanger.

The mobile power bank can further include a phase converter configured to convert a single-phase power to three phase power.

The mobile power bank can further include a plurality of tie-down points disposed around a perimeter of the deck.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale and may be exaggerated to better illustrate the important features of the present invention.

FIG. 1A and FIG. 1B are schematic top and side views, respectively, of a mobile power bank in the form of a trailer or a trailer dolly, according to an aspect of the invention.

FIG. 2 is a diagram showing various use-cases for a mobile power bank, according to an aspect of the invention.

FIG. 3A and FIG. 3B are schematic top and side views, respectively, of a mobile power bank in the form of a trailer or a trailer dolly, according to an aspect of the invention.

FIG. 4 is a flow or process diagram of a method for operating a portable or mobile power bank, according to an aspect of the invention.

FIG. 5 is a schematic side view of a mobile power bank in the form of a trailer with items of cargo loaded onto the cargo deck thereof, according to an aspect of the invention.

FIG. 6 is a schematic top view of a mobile power bank being moved from a first location to a second location at which the mobile power bank is connected to remotely located components, according to an aspect of the invention.

### DETAILED DESCRIPTION

Disclosed herein are systems, methods, devices, and/or vehicles for implementing a portable or mobile power bank. The mobile power bank can be in the form of a trailer or a trailer dolly. A mobile power bank trailer can be configured to haul additional items of cargo on a trailer deck thereof. The mobile power bank includes a battery disposed below or flush with the cargo deck. In this manner, the cargo deck is free to transport additional items of cargo together with the battery and related power bank components. The mobile power bank can further include a pass-through inverter, an on-board charger, a charge controller, and inlet/outlet receptacles packaged with the frame of the trailer or on the trailer dolly.

Customers are seeking reliable and effective access to mobile power solutions especially when driving or towing products that require electrical charging. A mobile power bank maximizes towing space and capacity by integrating the power bank or generator on a trailer dolly, within the frame, or below (or flush with) the floorboard of a trailer. The compact design allows for additional dolly/trailer towing space and/or capacity (GCWR). A mobile power bank provides customers with greater access to electrical power with or without the utility grid.

A mobile power bank can be capable of powering camping equipment (e.g., air mattress inflator, tent fan, lights, flash lights, etc.), tools (e.g., electric saws), home appliances, and/or any other electrically powered device (e.g., a stereo or a TV for tailgating, etc.). The mobile power bank allows users to take it with them (e.g., A/C and/or DC power “on-the-go”) by towing the mobile power bank behind a towing vehicle. The portable power station can act as an inverter for A/C power. The portable power station can act as an inverter for A/C power using electric power from the battery and/or another externally coupled power source. In this manner, the mobile power bank can integrate with external power sources for extended durations and/or high power (e.g., peak) loads.

A mobile power bank can provide improved electrical power bank mobility without sacrificing valuable storage space. The mobile power bank can be built into a frame of a trailer or on a trailer dolly. The mobile power bank can be towed by passenger vehicles and/or light trucks. In addition to an onboard battery, the weight is minimized and the capacity maximized by offering pass through power from other electrical generators, grids, and/or shore power.

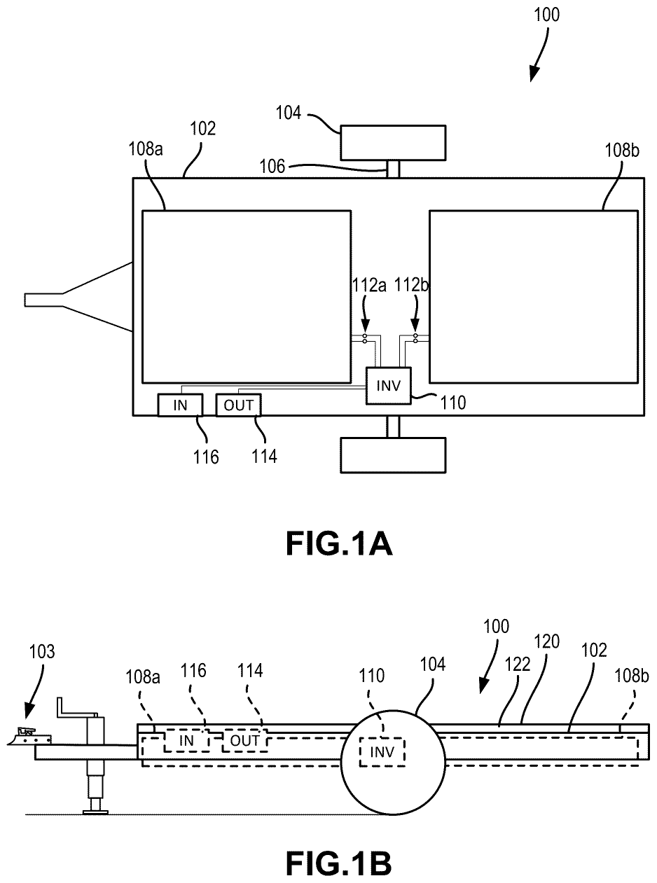

FIG. 1A shows a schematic top view of a mobile power bank 100, in accordance with various aspects. A mobile power bank 100 can be in the form of a trailer or a trailer dolly generally including a trailer frame 102 supported by wheels 104 coupled to a trailer axle 106. One or more batteries or battery packs (e.g., a first battery 108a and a second battery 108b; referred to generally as a battery 108) can be mounted to the trailer frame 102. The trailer frame 102 can include a trailer coupler 103 whereby the mobile power bank 100 is coupled to a towing vehicle for towing the mobile power bank 100 to a desired location.

The mobile power bank 100 can further include an inverter circuit, referred to herein generally as a power inverter 110, mounted to the frame 102. The power inverter 110 can be electrically connected to the battery 108 through a DC-side connector (e.g., connected to the battery 108a through a DC-side connector 112a and/or connected to the battery 108b through a DC-side connector 112b; referred to generally as DC-side connector 112), and the battery 108 and the inverter circuit perform power transmission/reception therebetween.

In a case where the battery 108 is operated to supply power to an external load (e.g., a towing vehicle such as a motorhome, a recreational vehicle (RV), a sport utility vehicle (SUV), a truck, a tractor, a car, or any other vehicle suitable of towing the mobile power bank 100), the inverter circuit 140 generates AC power based on DC power supplied from the battery 108 through the DC-side connector 112 and supplies the generated AC power to the external load through an AC connector 114.

In one aspect, by operating the mobile power bank 100 as a power source using electric power of the battery 108, a towing vehicle can be driven using the power of the towed vehicle—i.e., the mobile power bank 100. In various aspects, the mobile power bank 100 can further be operated to power any desired external load (e.g., construction site equipment/tools, camp equipment, offroad equipment, household equipment, food truck equipment, or any other desired electrical components).

In various aspects, the inverter 110 can be a pass-through inverter configured to provide pass through power from an external power source (e.g., electrical generators, grids, shore power, solar power, etc.). In this regard, the mobile power bank 100 can include an inlet connector 116. The inlet connector 116 can be configured to receive electrical power from the external power source. The inverter 110 can be configured to provide pass through power from the external power source to the AC connector 114 for supplementing and/or replacing power from the battery 108. In various aspects, the inverter 110 can be configured to facilitate charging of the battery 108 by connecting an external power source to the inlet connector 116, whereby the inverter 110 directs electrical current to the battery 108 for charging thereof.

In various aspects, the inlet connector 116 and the AC connector 114 are accessible from an exterior of the mobile power bank 100. For example, a user can stand or kneel next to the mobile power bank 100 when connecting an external component to the inlet connector 116 and/or the AC connector 114.

FIG. 1B shows a schematic side view of a mobile power bank 100, in accordance with various aspects. The mobile power bank 100 can include a cargo surface 120 defined by a deck 122 of the mobile power bank 100. The deck 122 can be coupled to the frame 102 and the cargo surface 120 can define an upper surface of the mobile power bank 100. The cargo surface 120 can be configured to support cargo to be transported and towed behind a towing vehicle.

In various aspects, the battery 108 and the frame 102 are located in a common horizontal plane. For example, the battery 108 and the frame 102 can be located beneath, and/or flush with, the cargo surface 120. In various aspects, the power inverter 110 and the frame 102 are located in a common horizontal plane. For example, the power inverter 110 and the frame 102 can be located beneath, and/or flush with, the cargo surface 120. In various aspects, the inlet connector 116, the AC connector 114, and the frame 102 are located in a common horizontal plane. For example, the inlet connector 116, the AC connector 114, and the frame 102 can be located beneath, and/or flush with, the cargo surface 120. In this manner, the cargo surface 120 can remain available for loading cargo to the towed vehicle, in addition to the components of the mobile power bank 100 (i.e., the battery 108, the power inventor 110, and the connectors 114, 116).

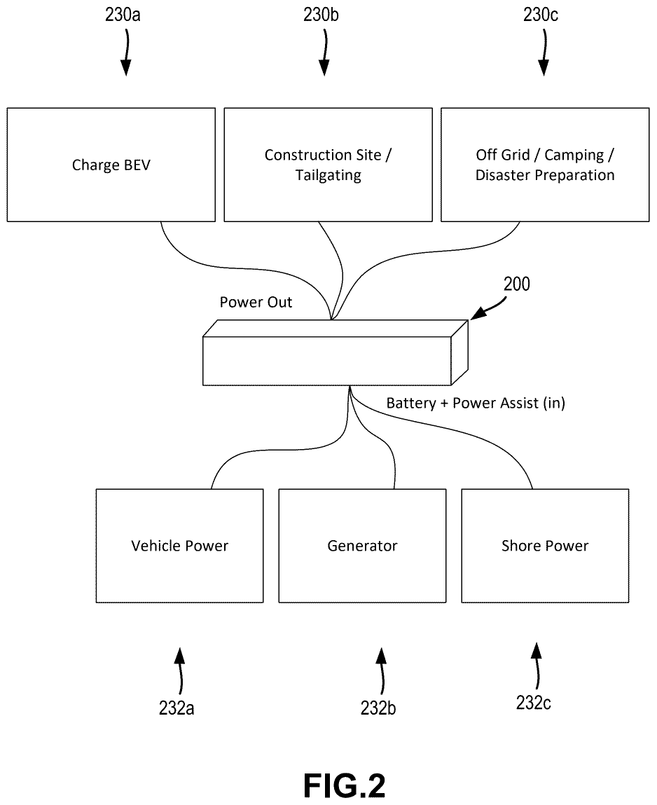

FIG. 2 shows a mobile power bank 200 electrically coupled with a plurality of external components, in accordance with various aspects. In various aspects, the mobile power bank 200 can be similar to the mobile power bank 100 described with respect to FIG. 1A and FIG. 1B, or any other mobile power bank described herein. The mobile power bank 200 can be in the form of a towed vehicle (e.g., a trailer).

In various aspects, the mobile power bank 200 can be configured to send electric power to an external component, such as a battery electric vehicle (BEV) 230a, electric components associated with a construction site and/or tailgating 230b, and/or off grid/camping/disaster preparation components 230c.

In various aspects, the mobile power bank 200 can be configured to receive electric power from an external power source, such as a towing vehicle power source 232a, a generator 232b, and/or from shore power 232c (e.g., an electric grid). Power received from the external power source can be used for charging the mobile power bank power source (e.g., the battery located onboard the mobile power bank) and/or for assisting with powering a separate external component.

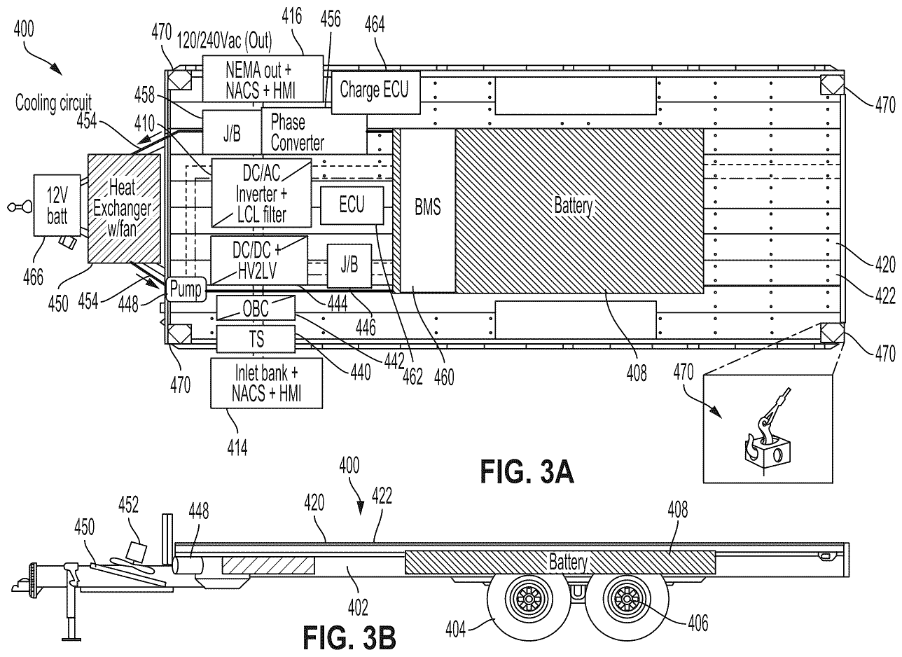

FIG. 3A and FIG. 3B show schematic top and side views, respectively, of a mobile power bank 400, in accordance with various aspects. In various aspects, the mobile power bank 400 can be similar to the mobile power bank 100 described herein. The mobile power bank 400 can be in the form of a trailer or a trailer dolly generally including a trailer frame 402 supported by wheels 404 coupled to a trailer axle 406. The mobile power bank 400 can include a cargo surface 420 defined by a deck 422 of the mobile power bank 400. The deck 422 can be coupled to the frame 402. The cargo surface 420 can define an upper surface of the mobile power bank 400.

One or more batteries or battery packs 408 can be mounted to the trailer frame 402. In various aspects, the battery 408 is mounted over the axle 406. In various aspects, the battery 408 is mounted beneath and/or flush with the cargo surface 420. In various aspects, the battery 408 can have a capacity of at least 1 kilowatt-hour (kWh). In various aspects, the battery 408 can have a capacity of at least 25 kWh. In various aspects, the battery 408 can have a capacity of at least 50 kWh. In various aspects, the battery 408 may include a lithium-ion battery; however, battery 104 is not limited in this regard and may comprise other rechargeable battery types such as a lead-acid battery, a nickel-cadmium battery, a nickel-metal hydride battery, a lithium polymer battery, a lithium iron sulfate battery, a lithium iron phosphate battery, a lithium sulfur battery, a solid state battery, a flow battery, or any other type of suitable battery. The battery 408 may further include multiple battery cells coupled in series and/or parallel to increase voltage and/or current supply. The cells of the battery 408 may include any suitable structure including cylindrical cells, prismatic cells, or pouch cells. Moreover, the battery 408 may at least partially comprise other energy storage technologies such as an ultracapacitor.

The mobile power bank 400 can include an external interface 414. The interface 414 can be a DC interface. The interface 414 can be accessible by a user standing next to the mobile power bank 400. The interface 414 can include inlet and/or outlet connectors. For example, the interface 414 can include electrical connectors (e.g., charging couplers such as NACS (North American Charging System) couplers) for charging a battery electric vehicle or other battery-powered component using the mobile power bank 400 as a power source. The interface 414 can include an inlet bank (e.g., electrical connectors) for receiving DC electrical power from an external power source. The electric power received via the interface 414 can be used for charging the battery 408 and/or for pass-through electrical power to a towing vehicle or other external system that the mobile power bank 400 is being used to power. The interface 414 can include a human machine interface (HMI) such as a touch screen, a keyboard, a button, and/or a switch, etc. for adjusting a setting of one or more components of the mobile power bank 400. The interface 414 can include connections similar to those described with respect to connectors 114, 116 (see FIG. 1A and FIG. 1B).

The mobile power bank 400 can include a transfer switch 440. The transfer switch 440 can be a static transfer switch. The transfer switch 440 can be an automatic transfer switch. The transfer switch 440 can be configured to transfer electrical loads between two independent power sources. The transfer switch 440 can be used when powering an external load that is receiving power from both the battery 408 and an external power source connected via the interface 414. The transfer switch 440 can monitor two different power sources (e.g., two different batteries 408 or the battery 408 and an external power source) and selects the better option based on a failure of either source. In various aspects, the transfer switch 440 can include controls and metering, rectifiers (e.g., silicon-controlled rectifiers), and breaker and bus assemblies.

The mobile power bank 400 can include an on-board charger (OBC) 442. The on-board charger 442 can be an electrical device that converts alternating current (AC) from a charging station or other external power source into direct current (DC) to charge the battery 408. The OBC 442 can be configured to accept level 1 (AC) charging, level 2 (AC) charging, and/or level 3 (DC) charging.

The mobile power bank 400 can include a DC/DC converter 444 configured to supply one or more electrical components with DC power from the battery 408. The DC/DC converter 444 can be configured to supply the battery 408 with DC power from one or more external power sources, for example to charge the battery. In this regard, the DC/DC converter 444 can be configured to route DC power from the interface 414 and/or the interface 416 to the battery 408 and/or can be configured to route DC power from the battery 408 to the interface 414. The DC/DC converter 444 can be electrically connected to the battery 408 through a DC-side connector 446, such as a junction box or other electrical connector. The DC/DC converter 444 can be used to route DC power to other components located onboard the mobile power bank 400 (e.g., trailer lights, trailer brakes, controllers, electrical circuit components, etc.). The DC/DC converter 444 can be configured to convert power from a high voltage to a lower voltage (e.g., High Voltage to Low Voltage) for operating various components, such as the pump 448, the trailer lights, the auxiliary battery 466, ECUs 462, 464, the interfaces 414, 416, etc.

The mobile power bank 400 can further include a power inverter 410. The power inverter 410 can be a DC/AC converter and/or an AC/DC converter. The power inverter 410 can be mounted to the frame 402. The power inverter 410 can be electrically connected to the battery 408. The power inverter 410 can be electrically connected to the battery 408 through a DC-side connector. The battery 408 and the power inverter 410 can perform power transmission and reception therebetween. The power inverter 410 can include a line filter (e.g., an LCL filter) to reduce harmonic currents in the power inverter 410. The power inverter 410 can be configured to route AC power from the interface 414 to the battery 408 in the form of DC power and/or can be configured to route DC power from the battery 408 to the interface 414 in the form of AC power. The power inverter 410 can be used to route AC power to other components located onboard the mobile power bank 400, such as the interface 414 and/or a heat exchanger 450 and/or a pump 448.

The mobile power bank 400 can further include an electronic control unit (ECU) 462. The ECU 462 can include one or more controllers (e.g., processors) and one or more tangible, non-transitory memories capable of implementing digital or programmatic logic. In various aspects, for example, the one or more controllers are one or more of an AI (artificial intelligence) chip, a general purpose processor or unit (GPU), a digital signal processor (DSP), an application specific integrated circuit (ASIC), a field programmable gate array (FPGA), or other programmable logic device, discrete gate, transistor logic, or discrete hardware components, or any various combinations thereof or the like. In various aspects, the ECU 462 controls, at least various parts of, and operation of various components of, the mobile power bank 400. For example, the ECU 462 controls various parameters of the mobile power bank 400 such as battery state of charge, voltage, current, etc.

The mobile power bank 400 can include a battery management system (BMS) 460. The BMS 460 can include one or more controllers (e.g., processors) and one or more tangible, non-transitory memories capable of implementing digital or programmatic logic. The BMS 460 can be in electronic communication with the ECU 462. When the mobile power bank 400 is running, the BMS 460 can provide the battery voltage and/or the battery temperature to the ECU 462 (e.g., an energy storage converter (Power Conversion System, PCS) and/or the energy storage monitoring and energy management system (energy management system, EMS). Battery state of charge (SOC) can be used to reflect the remaining capacity of the battery 408. The BMS 460 can be configured to ensure internal balancing of the battery 408 with respect to voltage and/or state of charge.

The mobile power bank 400 can include an external interface 416. The interface 416 can be an AC interface and/or a DC interface (e.g., a NACS connector can allow both AC and DC). The interface 416 can be accessible by a user standing next to the mobile power bank 400. The interface 416 can include inlet and/or outlet connectors. For example, the interface 416 can include electrical connectors (e.g., charging couplers such as NACS (North American Charging System) electrical couplers and/or NEMA (National Electrical Manufacturers Association) output electrical couplers—e.g., power plugs and/or sockets) for providing and/or receiving electrical power. The interface 416 can include an inlet bank (e.g., electrical connectors) for receiving AC electrical power from an external power source. The electric power received via the interface 416 can be used for charging the battery 408 and/or for pass-through electrical power to a towing vehicle or other external system that the mobile power bank 400 is being used to power. The interface 416 can include an outlet bank (e.g., electrical connectors) for supplying AC electrical power from the mobile power bank 400. The interface 416 can include a human machine interface (HMI) such as a touch screen, a keyboard, a button, a switch, etc. for adjusting a setting of one or more components of the mobile power bank 400. The interface 416 can include connections similar to those described with respect to connectors 114, 116 (see FIG. 1A and FIG. 1B).

The mobile power bank 400 can include a phase converter 456. The phase converter 456 can be electrically coupled to the power inverter 410. The phase converter 456 can be configured to convert single phase power to three phase power. Stated differently, the phase converter 456 can create a third line of voltage (a third sine wave) allowing three phase power to be possible in a single-phase environment. The phase converter 456 can be electrically connected to the power inverter 410 through an AC-side connector 458, such as a junction box or other electrical connector.

The mobile power bank 400 can include a charge ECU 464. The charge ECU 464 can include one or more controllers (e.g., processors) and one or more tangible, non-transitory memories capable of implementing digital or programmatic logic. The charge ECU 464 can be in electronic communication with the ECU 462. The charge ECU 464 can use an international standard (e.g., ISO 15118) that allows the mobile power bank 400 to communicate with a charging station, a plug-in hybrid vehicle, and/or a battery electric vehicle. The charge ECU 464 can be configured to send the state of charge of the battery 408 to the charging station, the plug-in hybrid vehicle, and/or the battery electric vehicle. The ECU 462 and/or the charge ECU 464 can determine an energy amount (kWh) to request based on various factors such as a state of charge and/or a temperature of the battery 408.

In various aspects, the mobile power bank 400 can include a power bank cooling circuit including a pump 448, a heat exchanger 450, a fan 452, and a conduit 454. The pump 448 can be configured to move a cooling fluid (e.g., a cooling liquid) through the conduit 454 in a closed circuit so that the cooling fluid receives heat generated by the battery 408 and transfers the heat to the heat exchanger 450. The fan 452 can direct a flow of air over, across, and/or through the heat exchanger 450 to transfer heat to the flow of air. The pump 448 can be any suitable fluid (i.e., gas, air, or liquid) pump. The pump 448 can be powered by the battery 408 via the power inverter 410. The heat exchanger 450 can be any suitable heat exchanger, including but not limited to, finned heat exchangers, air cooled exchangers, and the like. The heat exchanger 450 can be mounted to the frame 402. In various aspects, the heat exchanger 450 is mounted forward of the deck 422.

The mobile power bank 400 can include an auxiliary battery 466. The auxiliary battery 466 can be a 12-volt battery, in accordance with various aspects. The auxiliary battery 466 can be used for powering various electronics and/or electrical components of the mobile power bank 400, such as the pump 448, the fan 452, trailer lights, trailer brakes, controllers, and/or any other suitable equipment.

In various aspects, the mobile power bank 400 can include one or more tie-down points 470. For example, the mobile power bank 400 can include a plurality of discrete tie-down points 470 disposed around the perimeter of the trailer deck 422. The tie-down points 470 can be used for securing cargo to the trailer deck 422. The tie-down points 470 can be used as a lifting point for a crane, a helicopter, or other mobility or emergency deployment needs.

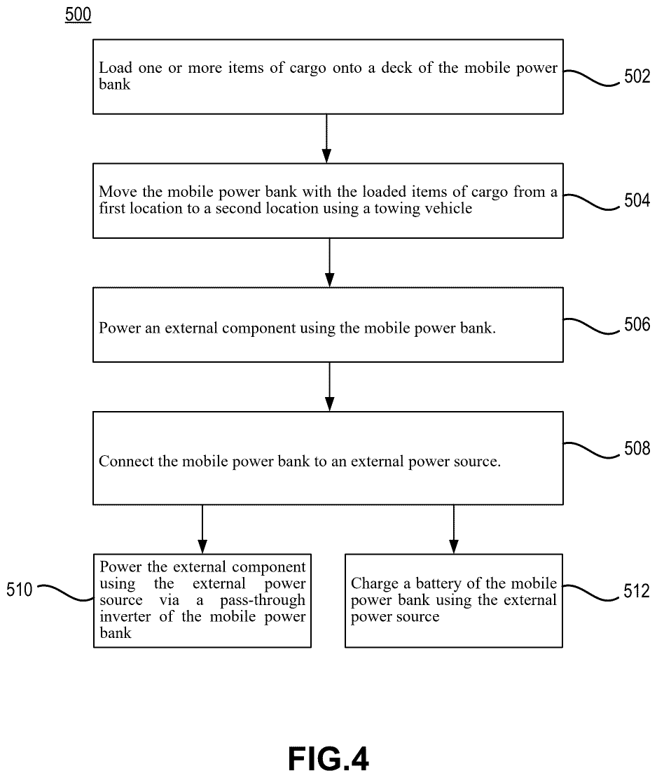

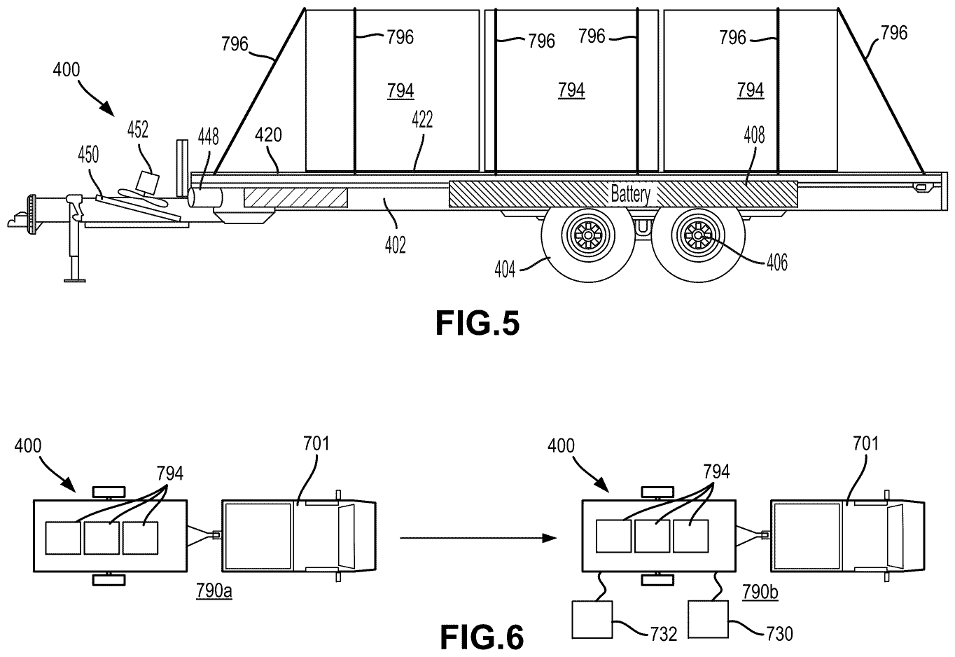

With reference to FIG. 4, a flowchart illustrating a method 500 is provided, in accordance with various aspects. In various aspects, the method 500 is a method for operating a mobile power bank. For ease of description, the method 500 is described below with reference to FIG. 3A, FIG. 3B, FIG. 5, and FIG. 6. The method 500 of the present disclosure, however, is not limited to use of the exemplary mobile power station 400 of FIG. 3A FIG. 3B, FIG. 5, and FIG. 6.

In step 502, and with particular focus on FIG. 5, the method 500 includes loading one or more items of cargo 794 onto the deck 422 of the mobile power bank 400. The one or more items of cargo 794 can be loaded onto the deck 422 by hand or using machinery (e.g., a forklift, a crane, a tractor, etc.).

In step 504, and with particular focus on FIG. 6, the method 500 includes moving the mobile power bank 400 with the loaded items of cargo 794 from a first location 790a to a second location 790b using a towing vehicle 701. The second location 790b can be located remotely from the first location 790a. The second location 790b can be located greater than a mile (1.6 kilometers) from the first location 790a.

In step 506, the method 500 includes powering an external component 730 using the mobile power bank 400. The external component 730 can be powered using only the battery of the mobile power bank 400 (i.e., without an external power source). For example, the external component 730 can be electrically coupled with the mobile power bank 400 via one of the external interfaces 414, 416. The ECU 462 can control voltage and/or current being supplied to the external component 730. The external component 730 can be similar to any of the external components 230 described with respect to FIG. 2, in accordance with various aspects.

In step 508, the method 500 can further include connecting the mobile power bank to an external power source 732. For example, the external power source 732 can be electrically coupled with the mobile power bank 400 via one of the external interfaces 414, 416. The ECU 462 can control voltage and/or current being supplied to the mobile power bank 400 via the external power source 732. The external power source 732 can be similar to any of the external power sources 232 described with respect to FIG. 2, in accordance with various aspects.

In step 510, the method 500 can further include powering the external component 730 using the external power source 732 via the power inverter 410. For example, the power inverter 410 can direct electrical power from one or both of the battery 408 and the external power source 732 to the external component 730. The ECU 462 and/or the transfer switch 440 can manage power being sent to the external component 730.

In step 512, the method 500 can further include charging the battery 408 of the mobile power bank 400 using the external power source 732. The ECU 462 can manage power being sent to the battery 408 from the external component 730 using the battery state of charge information received from the BMS 460.

Exemplary aspects of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such aspects that reasonably fall within the scope of the advancement to the art hereby contributed, and that that scope shall not be restricted, except in light of the appended claims and their equivalents.

Benefits, other advantages, and solutions to problems have been described herein with regard to specific aspects. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosure. The scope of the disclosure is accordingly to be limited by nothing other than the appended claims, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

Systems, methods and apparatus are provided herein. In the detailed description herein, references to “various embodiments,” “one embodiment,” “an embodiment,” “an example embodiment,” “various aspects,” “one aspect,” “an aspect,” “an example aspect,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments.

Furthermore, no element, component, or method step in the present disclosure is intended to be dedicated to the public regardless of whether the element, component, or method step is explicitly recited in the claims. No claim element herein is intended to invoke 35 U.S.C. 112(f), unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

1. A mobile power bank for a vehicle, the mobile power bank comprising:
a towed vehicle frame including a trailer coupler whereby the mobile power bank is configured to be towed behind a towing vehicle;
a deck mounted to the towed vehicle frame, the deck defines a cargo surface;
a battery coupled to the towed vehicle frame, the battery is disposed at least one of below or flush with the cargo surface;
a pass-through power inverter coupled to the towed vehicle frame;
a DC/DC converter coupled to the towed vehicle frame;
an AC interface in electronic communication with the battery via the pass-through power inverter; and
a DC interface in electronic communication with the battery via the DC/DC converter.

2. The mobile power bank of claim 1, further comprising an outlet connector configured to receive electric power from the battery for powering an external component, the outlet connector is part of at least one of the AC interface or the DC interface.

3. The mobile power bank of claim 2, further comprising an inlet connector configured to receive electric power from an external power source for at least one of charging the battery or assisting in powering the external component, the inlet connector is part of at least one of the AC interface or the DC interface.

4. The mobile power bank of claim 3, further comprising a transfer switch configured to transfer electrical loads between two independent power sources, and the battery is one of the two independent power sources.

5. The mobile power bank of claim 4, wherein the external power source is the other of the two independent power sources.

6. The mobile power bank of claim 1, further comprising an electronic control unit configured to control one or more parameters of the mobile power bank.

7. The mobile power bank of claim 1, further comprising a power bank cooling circuit including a heat exchanger, a conduit, and a pump configured to move a cooling fluid to transfer a heat from the battery to the heat exchanger.

8. The mobile power bank of claim 1, further comprising a phase converter configured to convert a single-phase power to three phase power.

9. The mobile power bank of claim 1, further comprising a plurality of tie-down points disposed around a perimeter of the deck.

10. A towed vehicle comprising:
a towed vehicle frame including a trailer coupler whereby the towed vehicle is configured to be towed behind a towing vehicle;
a deck mounted to the towed vehicle frame, the deck defines a cargo surface;
a battery coupled to the towed vehicle frame, the battery is disposed at least one of below or flush with the cargo surface;
a pass-through power inverter coupled to the towed vehicle frame;
a DC/DC converter coupled to the towed vehicle frame;
an AC interface in electronic communication with the battery via the pass-through power inverter; and
a DC interface in electronic communication with the battery via the DC/DC converter.

11. The towed vehicle of claim 10, further comprising an outlet connector configured to receive electric power from the battery for powering an external component, the outlet connector is part of at least one of the AC interface or the DC interface.

12. The towed vehicle of claim 11, further comprising an inlet connector configured to receive electric power from an external power source for at least one of charging the battery or assisting in powering the external component, the inlet connector is part of at least one of the AC interface or the DC interface.

13. The towed vehicle of claim 12, further comprising a transfer switch configured to transfer electrical loads between two independent power sources, and the battery is one of the two independent power sources.

14. The towed vehicle of claim 13, wherein the external power source is the other of the two independent power sources.

15. The towed vehicle of claim 10, further comprising an electronic control unit configured to control one or more parameters of the towed vehicle.

16. The towed vehicle of claim 10, further comprising a power bank cooling circuit including a heat exchanger, a conduit, and a pump configured to move a cooling fluid to transfer a heat from the battery to the heat exchanger.

17. The towed vehicle of claim 10, further comprising a phase converter configured to convert a single-phase power to three phase power.

18. The towed vehicle of claim 10, further comprising a plurality of tie-down points disposed around a perimeter of the deck.

19. A method for operating a mobile power bank, the method comprising:
loading one or more items of cargo onto a deck of the mobile power bank;
moving the mobile power bank with the loaded items of cargo from a first location to a second location using a towing vehicle; and
powering an external component using the mobile power bank.

20. The method of claim 19, further comprising:
connecting the mobile power bank to an external power source; and
at least one of:
powering the external component using the external power source via a pass-through inverter of the mobile power bank; and
charging a battery of the mobile power bank using the external power source.
